(19) United States
(12) Patent Application Publication
(10) Pub. No.: US 2017/0123282 A1
(43) Pub. Date: May 4, 2017

(54) LIQUID CRYSTAL DISPLAY DEVICE

(71) Applicant: Japan Display Inc., Minato-ku (JP)

(72) Inventor: Takeyuki TSURUMA, Tokyo (JP)

(73) Assignee: Japan Display Inc., Minato-ku (JP)

(21) Appl. No.: 15/337,487

(22) Filed: Oct. 28, 2016

(30) Foreign Application Priority Data
Nov. 2, 2015 (JP) 2015-215907

(51) Int. Cl. G02F 1/1343; G02F 1/1362; G02F 1/1368; G02F 1/1333; G02F 1/137

(52) U.S. Cl. CPC G02F 1/134363; G02F 1/133345; G02F 1/137; G02F 1/1368; G02F 1/136286; G02F 2001/13712

(57) ABSTRACT

According to one embodiment, a liquid crystal display device includes a first substrate including a first electrode, and a second electrode, a second substrate, and a liquid crystal layer, the second electrode includes an edge, the edge includes a first portion, a second portion, and a middle part which is located between the first portion and the second portion and is bent, and liquid crystal molecules form a region, between the first portion and the second portion, in which the liquid crystal molecules are rotated in a same direction by an electric field produced between the first electrode and the second electrode.

### CROSS-REFERENCE TO RELATED APPLICATIONS

This application is based upon and claims the benefit of priority from Japanese Patent Application No. 2015-215907, filed Nov. 2, 2015, the entire contents of which are incorporated herein by reference.

### FIELD

Embodiments described herein relate generally to a liquid crystal display device.

### BACKGROUND

Recently, liquid crystal display devices of a lateral electric field mode have been put into practical use. In the lateral electric field mode, by using an electric field produced between a pixel electrode and a common electrode provided on the same substrate, the alignment state of liquid crystal molecules is controlled. As an example of the lateral electric field mode, a liquid crystal panel comprising a pixel electrode pattern in which an electrode branch whose extending direction is refracted at a bending point provided closer to an upper part of a pixel than the center of a pixel region is connected to at least a terminal portion of the upper part of the pixel or a lower part of the pixel is known. In such a liquid crystal display device, from various standpoints, improvement of display quality is desired.

### BRIEF DESCRIPTION OF THE DRAWINGS

FIG. 1 is a plan view showing the structure of a liquid crystal display device according to the present embodiment.

FIG. 2 is a plan view showing a structure example of one pixel PX in a first substrate SUB1 shown in FIG. 1.

FIG. 3 is a cross-sectional view of the first substrate SUB1 taken along line A-B of FIG. 2.

FIG. 4 is a cross-sectional view of a display panel PNL taken along line C-D of FIG. 2.

FIG. 5 is an illustration for explaining the operation of a liquid crystal display device to which a negative liquid crystal material is applied.

FIG. 6 is an illustration for explaining the operation of a liquid crystal display device to which a positive liquid crystal material is applied.

FIG. 7 represents graphs each showing the simulation result of a V-T characteristic of a case where a negative liquid crystal material is applied.

FIG. 8 is a graph showing the simulation result of a liquid crystal response time of a case where a negative liquid crystal material is applied.

FIG. 9 is a plan view showing another structure example of one pixel PX in the first substrate SUB1 shown in FIG. 1.

FIG. 10 is a plan view showing yet another structure example of one pixel PX in the first substrate SUB1 shown in FIG. 1.

FIG. 11 is a plan view showing yet another structure example of one pixel PX in the first substrate SUB1 shown in FIG. 1.

### DETAILED DESCRIPTION

In general, according to one embodiment, a liquid crystal display device includes: a first substrate including a first line, a second line separated from the first line, a first electrode, a second electrode opposed to the first electrode, and an interlayer insulating film located between the first electrode and the second electrode; a second substrate opposed to the first substrate; and a liquid crystal layer including liquid crystal molecules which is held between the first substrate and the second substrate, the second electrode comprising an edge located between the first electrode and the liquid crystal layer, the edge comprising a first portion located closer to the first line, a second portion located closer to the second line, and a middle part which is located between the first portion and the second portion and is bent, and the liquid crystal molecules form a region, between the first portion and the second portion, in which the liquid crystal molecules are rotated in a same direction by an electric field produced between the first electrode and the second electrode.

According to another embodiment, a liquid crystal display device includes: a first substrate including a first electrode, a second electrode opposed to the first electrode, and an interlayer insulating film located between the first electrode and the second electrode; a second substrate opposed to the first substrate; and a liquid crystal layer including liquid crystal molecules which is held between the first substrate and the second substrate, the second electrode comprising an edge located between the first electrode and the liquid crystal layer, the edge comprising a first portion, a second portion, and a middle part which is located between the first portion and the second portion and is bent, the middle part comprising a third portion extending parallel to the first portion, and a fourth portion extending in a direction different from a direction in which the third portion extends, and the liquid crystal molecules form a region, between the first portion and the second portion, in which the liquid crystal molecules are rotated in a same direction by an electric field produced between the first electrode and the second electrode.

According to another embodiment, a liquid crystal display device includes: a first substrate including a first electrode, a second electrode opposed to the first electrode, and an interlayer insulating film located between the first electrode and the second electrode; a second substrate opposed to the first substrate; and a liquid crystal layer including liquid crystal molecules which is held between the first substrate and the second substrate, the second electrode comprising an edge located between the first electrode and the liquid crystal layer, the edge being constituted of first portions and second portions which are arranged alternately, the second portions extending in a direction different from a direction in which the first portions extend, and the liquid crystal molecules form a region, along the edge, in which the liquid crystal molecules are rotated in a same direction by an electric field produced between the first electrode and the second electrode.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc. of the respective parts are schematically illustrated in the drawings, compared to the actual modes. However, the schematic illustration is merely an example, and adds no restrictions to the interpretation of the invention. Furthermore, in the description and figures of the present application, structural elements, which have functions identical or similar to the functions described in connection with preceding drawings, are denoted by the same reference numbers, and detailed explanations of them that are considered redundant may be omitted.

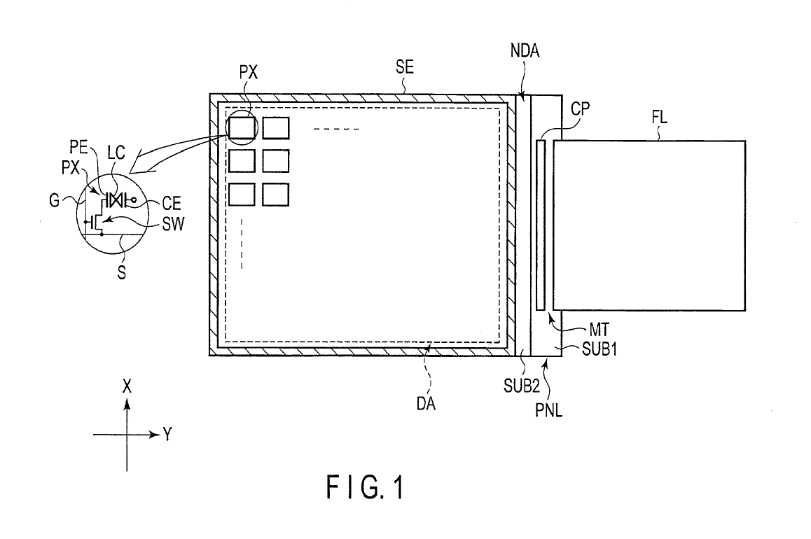

FIG. 1 is a plan view showing the structure of a liquid crystal display device according to the present embodiment.

That is, a display panel PNL which constitutes the liquid crystal display device includes a first substrate SUB1, a second substrate SUB2 opposed to the first substrate SUB1, and a liquid crystal layer LC held between the first substrate SUB1 and the second substrate SUB2. The first substrate SUB1 and the second substrate SUB2 are adhered to each other by a sealant SE with a predetermined gap formed therebetween. The liquid crystal layer LC is held inside an area surrounded by the sealant SE in the gap between the first substrate SUB1 and the second substrate SUB2. The display panel PNL includes a display area DA in which an image is displayed inside the area surrounded by the sealant SE. The display area DA is composed of a plurality of pixels PX. In the example illustrated, the display area DA is formed rectangular, but it may be formed in a different polygonal shape or another shape such as circular or elliptical.

The first substrate SUB 1 comprises a gate line G, a source line S, a switching element SW, a pixel electrode PE, a common electrode CE, and the like, in the display area DA. The gate line G extends along a first direction X, for example. The source line S extends along a second direction Y intersecting the first direction X. In the example illustrated, the first direction X and the second direction Y are orthogonal to each other. Note that the gate line G need not be formed as a linear shape parallel to the first direction X, and the source line S need not be formed as a linear shape parallel to the second direction Y. That is, the gate line G and the source line S may be bent or may be partly branched.

The switching element SW is electrically connected to the gate line G and the source line S in each pixel PX. The pixel electrode PE is electrically connected to the switching element SW in each pixel PX. The common electrode CE is provided to be common to the plurality of pixels PX, and is set to a common potential.

Signal supply sources necessary to drive the display panel PNL, such as a drive IC chip CP and a flexible printed circuit (FPC) FL, are located in a non-display area NDA outside the display area DA. In the example illustrated, the drive IC chip CP and the FPC FL are mounted on a mounting portion MT of the first substrate SUB1 which extends more to the outer side than the second substrate SUB2.

Further, the display panel PNL is a transmissive display panel having a transmissive display function of displaying an image by, for example, selectively passing light from a backlight unit BL which will be described later, but is not limited to this. For example, the display panel PNL may be a reflective display panel having a reflective display function of displaying an image by selectively reflecting light from the display surface side, such as external light and auxiliary light. Furthermore, the display panel PNL may be a transflective display panel with both the transmissive and reflective display functions.

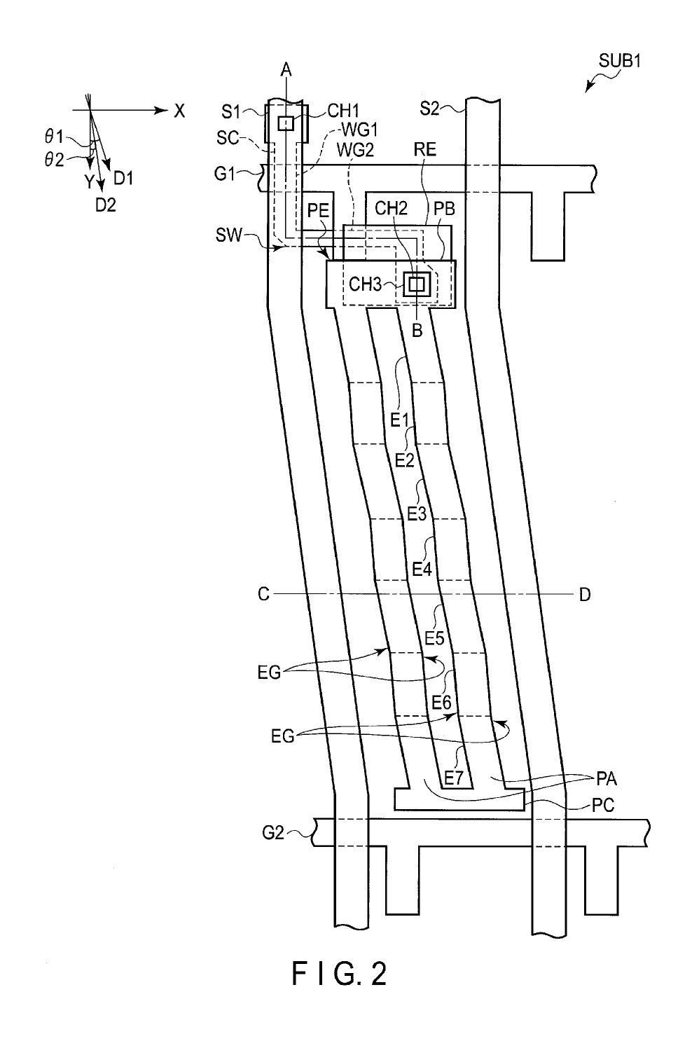

FIG. 2 is a plan view showing a structure example of one pixel PX in the first substrate SUB1 shown in FIG. 1. Here, the pixel structure of the display panel PNL to which one of the lateral electric field modes, i.e., the fringe field switching (FFS) mode, is applied will be described as an example of the display mode.

The first substrate SUB1 includes gate lines G1 and G2, source lines S1 and S2, the switching element SW, a relay electrode RE, the pixel electrode PE, etc. Note that illustration of the common electrode CE is omitted.

The gate lines G1 and G2 extend along the first direction X, and are arranged in the second direction Y to be spaced apart from each other. The source lines S1 and S2 extend substantially along the second direction Y, and are arranged in the first direction X to be spaced apart from each other. The gate lines G1 and G2 and the source lines S1 and S2 cross one another.

The switching element SW is located near the intersection of the gate line G1 and the source line S1, and is electrically connected to the gate line G1 and the source line S1. The switching element SW includes a semiconductor layer SC. Although the switching element SW of the example illustrated has a double-gate structure comprising gate electrodes WG1 and WG2, the switching element SW is not limited to the illustration, and may have a single-gate structure, for example. Each of the gate electrodes WG1 and WG2 is a part of the gate line G1 opposed to the semiconductor layer SC. One end side of the semiconductor layer SC is electrically connected to the source line S1 while the other end side of the semiconductor layer SC is electrically connected to the pixel electrode PE. The source line S1 is in contact with the one end side of the semiconductor layer SC through a contact hole CH1. The relay electrode RE is located between the other end side of the semiconductor layer SC and the pixel electrode PE. The relay electrode RE is in contact with the other end side of the semiconductor layer SC through a contact hole CH2. The pixel electrode PE is in contact with the relay electrode RE through a contact hole CH3.

The pixel electrode PE of the example illustrated comprises a strip electrode (a linear electrode, a comb electrode) PA, a contact portion PB, and a connecting portion PC. In one example, one pixel electrode PE comprises two strip electrodes PA. These strip electrodes PA are arranged to be spaced apart from each other in the first direction X. The contact portion PB overlaps the relay electrode RE in an X-Y plane which is defined by the first direction X and the second direction Y. The connecting portion PC is located close to the gate line G2 between the gate lines G1 and G2. The strip electrodes PA are located between the contact portion PB and the connecting portion PC, and each of the strip electrodes PA is connected to the contact portion PB on one end side (the upper part in the drawing) of the strip electrode PA and connected to the connecting portion PC at the other end side (the lower part in the drawing) of the same. Note that the shape of the pixel electrode PE is not limited to the example illustrated. That is, for example, the connecting portion PC can be omitted, and the number of strip electrodes PA may not be two. However, as shown in the drawing, in a case where the pixel electrode PE is formed in a loop shape by the two strip electrodes PA, the contact portion PB, and the connecting portion PC, even if the width of the pixel electrode PE is reduced in accordance with achieving higher definition, it becomes possible to improve redundancy. That is, even if break occurs at a part of the pixel electrode PE, a pixel potential can be supplied to any parts via paths passing through the other parts.

Here, one strip electrode PA is noted. The strip electrode PA includes edges (end portions) EG on the sides close to the source line S1 and the source line S2, respectively. In the example illustrated, each of the edges EG includes portions E1 to E7. Portions E1 to E7 are arranged in the second direction Y in this order. That is, portion E1 corresponds to a first end portion located closer to the gate line G1 in the edge EG, and portion E7 corresponds to a second end portion located closer to the gate line G2 in the edge EG. Portions E2 to E6 correspond to a middle part located between portion E1 and portion E7. Portions E2 to E6 constitute the middle part in which portions extending in different directions are adjacent to each other and form a bent (non-straight) configuration. That is, the edge EG is formed to be wavy or in zigzags. In one example, portions E1 to E7 all have equal length. Note that the shape of the strip electrode PA or the shape of the edge EG is not limited to the illustrated example, and the number of portions included in the edge EG is also not limited to the illustrated example. The number of portions included in the edge EG is, for example, an odd number.

Here, the second direction Y which is orthogonal to the gate lines G1 and G2 is assumed as a reference direction. Each of portions E3 and E5 extends in direction D1 which intersects the second direction Y at a first angle θ1. Each of portions E2, E4, and E6 extends in direction D2 which intersects the second direction Y at a second angle θ2. Directions D1 and D2 are directions intersecting the second direction Y anticlockwise at an acute angle. The first angle θ1 is different from the second angle θ2. In the example illustrated, portions E1 and E7 extend in direction D1 likewise portion E3, etc. Of portions E1 to 57 which are arranged in the second direction Y, the odd-numbered portions E1, E3, E5, and E7 all extend in the same direction D1, and the even-numbered portions E2, E4, and E6 all extend in the same direction D2.

Note that in this specification, the first direction X, the second direction Y, direction D1, and direction D2 are not limited to those indicated by arrows in the figure, but include directions 180-degrees opposite to those indicated by the arrows.

Hereinafter, a preferred relationship between the first angle θ1 and the second angle θ2 will be described. First, the following relationships should preferably be satisfied:

5°≦θ1≦30°,0°≦θ2≦20°, and θ1>θ2≧0.

When a negative liquid crystal material having a negative dielectric anisotropy is applied as the liquid crystal layer LC, it is more desirable that the first angle θ1 and the second angle θ2 satisfy the following relationships:

10°≦θ1≦30°,0°≦θ2≦20°, and θ1>θ2≧0.

In this case, when a transmittance per one pixel which will be described later is considered, it is preferable that the following relationship be further satisfied:

θ1−θ2≧20°.

Also, when a liquid crystal response speed which will be described later is considered, it is preferable that the following relationship be further satisfied:

θ1−θ2≧10°.

Also, when a positive liquid crystal material having a positive dielectric anisotropy is applied as the liquid crystal layer LC, it is more desirable that the first angle θ1 and the second angle θ2 satisfy the following relationships:

5°≦θ1≦20°,0°≦θ2≦10°, and θ1>θ2≧0.

In this case, when a transmittance per one pixel which will be described later is considered, it is preferable that the following relationship be further satisfied:

θ1−θ2≧5°.

Referring to the example illustrated, a case where all of the edges EG have straight portions E1 to E7 has been described. However, the edges EG may be formed of curved lines. When the edges EG are formed of curved lines, it suffices that a tangential line at a middle point of adjacent vertexes, or a tangential line at an inflection point of the curved line extends in direction D1 or direction D2.

A region which overlaps the gate line G1 and the contact portion PB, and a region between the connecting portion PC and the gate line G2 overlap a light-shielding layer of the second substrate, although this is not illustrated in FIG. 2.

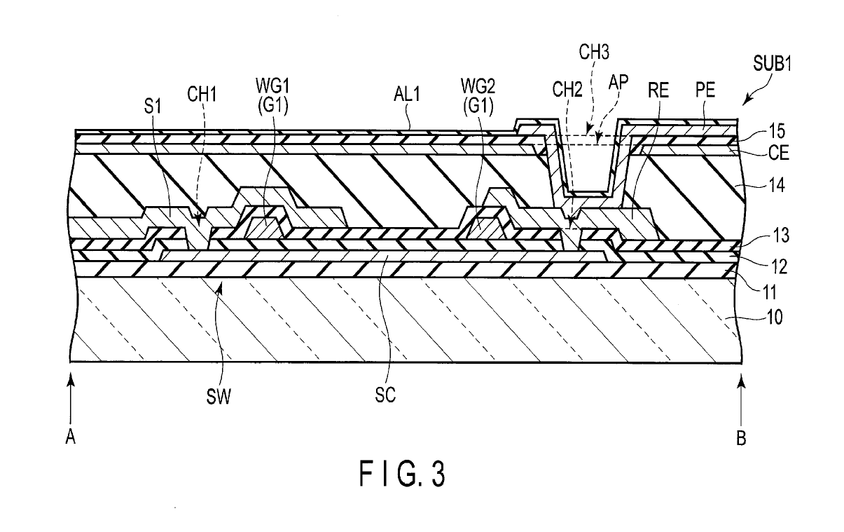

FIG. 3 is a cross-sectional view of the first substrate SUB1 taken along line A-B of FIG. 2. In the following descriptions, a direction from the first substrate SUB1 to the second substrate SUB2 is referred to as upward (or merely above), and a direction from the second substrate SUB2 to the first substrate SUB1 is referred to as downward (or merely below).

The first substrate SUB1 includes a first insulating substrate 10, a first insulating film 11, a second insulating film 12, a third insulating film 13, a fourth insulating film 14, a fifth insulating film 15, the switching element SW, the relay electrode RE, the pixel electrode PE, the common electrode CE, a first alignment film AL1, and the like. The switching element SW is of a top-gate type in the example illustrated, but it may be of a bottom-gate type.

The first insulating substrate 10 is a light transmissive substrate such as a glass substrate or a resin substrate. The first insulating film 11 is disposed on the first insulating substrate 10. The semiconductor layer SC of the switching element SW is disposed on the first insulating film 11. The semiconductor layer SC is formed of, for example, polycrystalline silicon, but may be formed of amorphous silicon, an oxide semiconductor or the like.

The second insulating film 12 is disposed on the first insulating film 11 and the semiconductor layer SC. The gate electrodes WG1 and WG2 which are part of the gate line G1 are disposed on the second insulating film 12, and are opposed to the semiconductor layer SC. The third insulating film 13 is disposed on the gate electrodes WG1 and WG2, and the second insulating film 12. The source line S1 and the relay electrode RE are disposed on the third insulating film 13. The source line S1 is in contact with the semiconductor layer SC through the contact hole CH1 which penetrates the second insulating film 12 and the third insulating film 13. The relay electrode RE is in contact with the semiconductor layer SC through the contact hole CH2 which penetrates the second insulating film 12 and the third insulating film 13. The fourth insulating film 14 is disposed on the third insulating film 13, the source line S1, and the relay electrode RE.

The common electrode CE is disposed on the fourth insulating film 14. The common electrode CE is opposed to the gate line G1, the source line S1, and the switching element SW. The common electrode CE is also opposed to the gate line G2, the source line S2, and the like, shown in FIG. 2. The common electrode CE has an aperture AP at a position opposed to the relay electrode RE.

The fifth insulating film 15 is disposed on the fourth insulating film 14 and the common electrode CE. The first insulating film 11, the second insulating film 12, the third insulating film 13, and the fifth insulating film 15 are formed of, for example, an inorganic material such as a silicon nitride (SiN) or a silicon oxide (SIO). The fourth insulating film 14 is formed of, for example, an organic material such as an acrylic resin.

The pixel electrode PE is disposed on the fifth insulating film 15 and is opposed to the common electrode CE. The pixel electrode PE is in contact with the relay electrode RE through the contact hole CH3 which penetrates the fourth insulating film 14 and the fifth insulating film 15. The common electrode CE and the pixel electrode PE are formed of, for example, a transparent conductive material such as indium tin oxide (ITO) or indium zinc oxide (IZO). The first alignment film AL1 is disposed on the fifth insulating film 15 and the pixel electrode PE. The first alignment film AL1 is formed of, for example, a material exhibiting a horizontal alignment property.

In the example illustrated, the common electrode CE corresponds to a first electrode, the pixel electrode PE corresponds to a second electrode, and the fifth insulating film 15 corresponds to an interlayer insulating film.

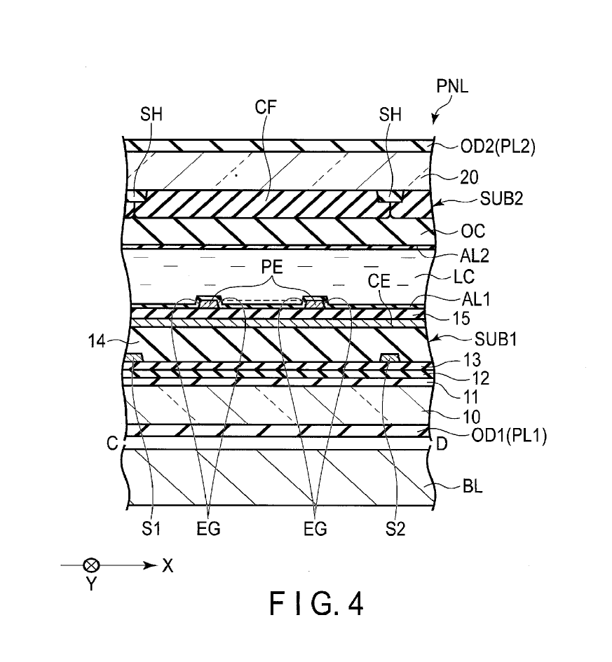

FIG. 4 is a cross-sectional view of the display panel PNL taken along line C-D of FIG. 2.

In the first substrate SUB1, the source lines S1 and S2 are disposed on the third insulating film 13, and are covered with the fourth insulating film 14. The common electrode CE is disposed on the fourth insulating film 14, and is covered with the fifth insulating film 15. The common electrode CE extends not only to a position opposed to the source lines S1 and S2, but also to a position opposed to the gate lines and switching element which are not shown. The pixel electrode PE is disposed on the fifth insulating film 15, and is covered with the first alignment film AL1. The pixel electrode PE is located more to the inner side than places directly above the source lines S1 and S2, and is opposed to the common electrode CE. The edges EG of the pixel electrode PE are positioned between the common electrode CE and the liquid crystal layer LC, and in the example illustrated, the edges EG of the pixel electrode PE are located directly above the common electrode CE.

The second substrate SUB2 includes a second insulating substrate 20, a light-shielding layer SH, color filters CF, an overcoat layer OC, a second alignment film AL2, etc.

The second insulating substrate 20 is a light transmissive substrate such as a glass substrate or a resin substrate. The light-shielding layer SH is disposed on the second insulating substrate 20 at the side which is opposed to the first substrate SUB1. The light-shielding layer SH is located directly above the source lines S1 and S2, and is also located directly above the gate lines and switching element which are not shown. The color filters CF are opposed to the pixel electrode PE. End portions of the respective color filters CF overlap the light-shielding layer SH. Each of the color filters CF is formed of a resin material colored in, for example, any one of red, green and blue. The color filters CF may include a white color filter or a transparent color filter. The overcoat layer OC is formed of a transparent resin material and covers the color filters CF. The second alignment film AL2 is disposed on the overcoat layer OC at the side which is opposed to the first substrate SUB1. The alignment film AL2 is formed of a material exhibiting a horizontal alignment property. Note that in the example illustrated, the color filters CF are provided in the second substrate SUB2, but they may be provided in the first substrate SUB1.

The first substrate SUB1 and the second substrate SUB2 described above are disposed such that the first alignment film AL1 and the second alignment film AL2 face each other. A predetermined cell gap is formed between the first substrate SUB1 and the second substrate SUB2. The liquid crystal layer LC is sealed between the first alignment film AL1 of the first substrate SUB1 and the second alignment film AL2 of the second substrate SUB2. The liquid crystal layer LC is composed of a liquid crystal material of a negative dielectric anisotropy or a liquid crystal material of a positive dielectric anisotropy.

The backlight unit BL is arranged on the rear side of the display panel PNL. Note that in the present embodiment, various types of backlight units BL are applicable, but explanation of the detailed structure is omitted.

A first optical element OD1 including a first polarizer PL1 is disposed on the outer surface of the first insulating substrate 10. A second optical element OD2 including a second polarizer PL2 is disposed on the outer surface of the second insulating substrate 20. A first polarization axis of the first polarizer PL1 and a second polarization axis of the second polarizer PL2 are in a crossed-Nicol relationship in the X-Y plane, for example.

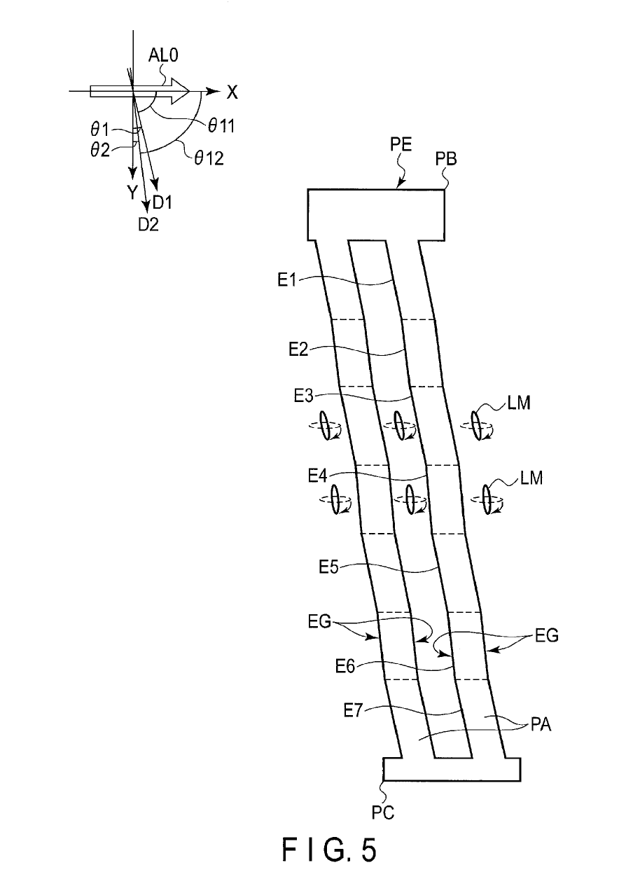

Next, the operation of the liquid crystal display device having the above structure will be described. First, a case where the liquid crystal layer LC is composed of a negative liquid crystal material will be described referring to FIG. 5.

In a state in which no voltage is applied to the liquid crystal layer LC, that is, at off-time when no electric field is produced between the pixel electrode PE and the common electrode CE, liquid crystal molecules LM are initially aligned as indicated by broken lines in the drawing in a direction in which their major axes are oriented substantially parallel to the first direction X in the X-Y plane. The drawing shows the liquid crystal molecules LM near portions E3 and E4 of the edges EG. Such an off-time corresponds to the initial alignment state, and the alignment direction of the liquid crystal molecules LM at the off-time corresponds to an initial alignment direction AL0. The initial alignment direction AL0 is perpendicular to the second direction Y (reference direction). The initial alignment state is implemented by aligning the first alignment film AL1 and the second alignment film AL2 in the first direction X. A method of the alignment treatment may be a rubbing treatment or the other methods such as an optical alignment treatment.

At the off-time, part of backlight from the backlight unit BL passes through the first polarizer PL1 and is made incident on the display panel PNL. The light made incident on the display panel PNL is linearly polarized light which is orthogonal to a first polarization axis (or absorption axis) AX1 of the first polarizer PL1. The polarized state of the linearly polarized light hardly varies when the light passes through the liquid crystal layer LC at the off-time. For this reason, the linearly polarized light which has passed through the display panel PNL is absorbed by the second polarizer PL2 having the crossed-Nicol relationship with the first polarizer PL1 (black display).

Meanwhile, in a state in which a voltage is applied to the liquid crystal layer LC, that is, at on-time when an electric field is produced between the pixel electrode FE and the common electrode CE, the liquid crystal molecules LM are aligned in a direction different from the initial alignment direction AL0, as indicated by solid lines in the drawing. In the drawing, an arrow indicates a direction of rotation of the liquid crystal molecules LM with respect to the initial alignment direction AL0. That is, an electric field produced at the on-time is formed along the edges EG of the pixel electrode PE in the X-Y plane, and the direction of the electric filed is substantially perpendicular to the edges EG. The liquid crystal molecules LM are affected by the electric field which has been formed, and the alignment state of the liquid crystal molecules LM is varied. In the case of a negative liquid crystal material, the liquid crystal molecules LM are aligned in such a direction that their major axes are aligned in a direction substantially perpendicular to the electric field.

In the present embodiment, the liquid crystal molecules form a region in which the liquid crystal molecules are rotated in the same direction relative to the initial alignment direction AL0 in an area along each of the portions of the edges EG. In the example illustrated, the liquid crystal molecules LM near portions E3 and E4 are all rotated clockwise with respect to the initial alignment direction AL0 in the X-Y plane, and aligned such that their major axes are oriented in a direction substantially parallel to the respective portions of the edges EG. Also in areas along the other portions of the edges EG, the liquid crystal molecules LM similarly form a region in which the liquid crystal molecules LM are rotated clockwise.

Portion E3 extends in a direction different from the direction in which portion E4 extends. For this reason, the liquid crystal molecules LM near portion E3 may be aligned in a direction different from that of the liquid crystal molecules LM near portion E4. That is, since portion E3 extends in direction D1, the liquid crystal molecules LM near portion E3 are aligned such that their major axes are oriented in a direction substantially parallel to direction D1. Also, since portion E4 extends in direction D2, the liquid crystal molecules LM near portion E4 are aligned such that their major axes are oriented in a direction substantially parallel to direction D2. However, as described above, since a difference between the first angle θ1 and the second angle θ2 is as small as 20° or less, and the liquid crystal molecules near portions E3 and E4 rotate in the same direction, it can be said that they form a substantially single domain.

Further, angle θ11 formed between the initial alignment direction AL0 and direction D1 is smaller than angle θ12 formed between the initial alignment direction AL0 and direction D2. Accordingly, energy required for rotation of the liquid crystal molecules LM near portion E3 is less than that of the liquid crystal molecules LM near portion E4. Consequently, the liquid crystal molecules LM near portion E3 tend to be rotated faster than the liquid crystal molecules LM near portion E4.

At such on-time, the polarized state of the linearly polarized light made incident on the display panel PNL is varied in accordance with the alignment state of the liquid crystal molecules LM when the linearly polarized light passes through the liquid crystal layer LC. Therefore, in the on-state, at least part of the light passing through the liquid crystal layer LC is transmitted through the second polarizer PL2 (white display).

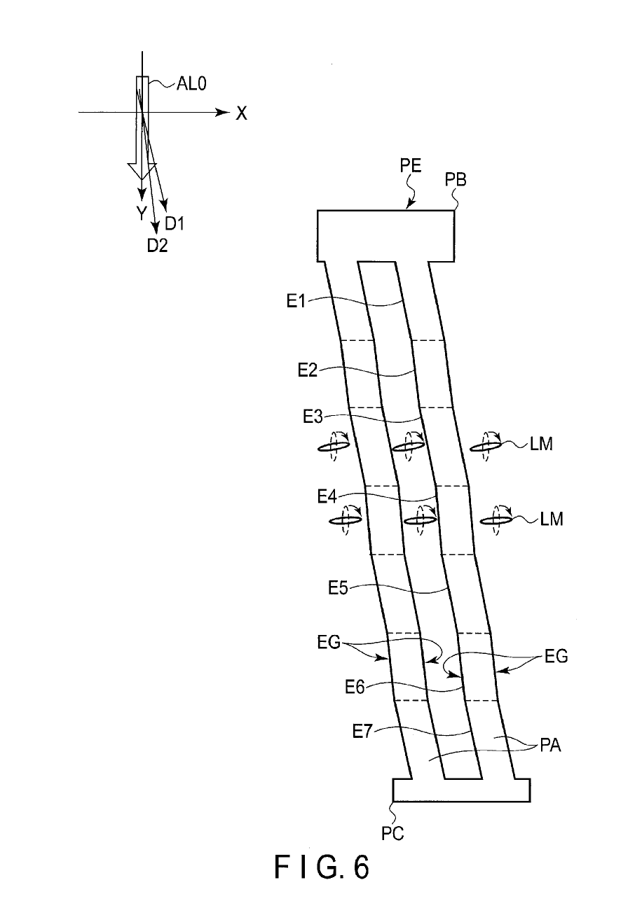

Next, when the liquid crystal layer LC is composed of a positive liquid crystal material, the operation of the liquid crystal display device having the above structure will be described referring to FIG. 6.

At the off-time, as shown by broken lines in the drawing, the liquid crystal molecules LM are initially aligned in a direction in which their major axes are oriented parallel to the second direction Y in the X-Y plane. The initial alignment direction AL0 is parallel to the second direction Y (reference direction). At such off-time, as has been explained with reference to FIG. 5, since the polarized state of the linearly polarized light made incident on the display panel PNL hardly varies when the linearly polarized light passes through the liquid crystal layer LC in the off-state, the linearly polarized light is absorbed by the second polarizer PL2 having the crossed-Nicol relationship with the first polarizer PL1 (black display).

At the on-time, the liquid crystal molecules LM are aligned in a direction different from the initial alignment direction AL0, as indicated by solid lines in the drawing. In the case of a positive liquid crystal material, the liquid crystal molecules LM are aligned in such a direction that their major axes are aligned in a direction substantially parallel to the electric field. In the example illustrated, the liquid crystal molecules LM near portions E3 and E4 are all rotated clockwise with respect to the initial alignment direction AL0 in the X-Y plane, and aligned such that their major axes are oriented in a direction substantially perpendicular to the respective portions of the edges EG. Also in areas along the other portions of the edges EG, the liquid crystal molecules LM similarly form a region in which the liquid crystal molecules LM are rotated clockwise.

At such on-time, the polarized state of the linearly polarized light made incident on the display panel PNL is varied in accordance with the alignment state of the liquid crystal molecules LM when the linearly polarized light passes through the liquid crystal layer LC, and at least part of the light is transmitted through the second polarizer PL2 (white display).

According to the present embodiment, the edges EG of the pixel electrode PE include the middle part which is bent in a space between the contact portion PB and the connecting portion PC. Accordingly, as compared to a case where the edges EG are formed linearly, an edge length can be increased. Moreover, when an electric field is produced along the edges EG of the pixel electrode PE, the liquid crystal molecules LM form a region in which the liquid crystal molecules LM are rotated in the same direction relative to the initial alignment direction, and form a substantially single domain. Accordingly, as compared to a case where the edges EG are formed linearly, it becomes possible to improve the transmittance per one pixel.

In addition, since a region where the liquid crystal molecules LM rotating in the opposite directions compete against each other does not exist in the areas along the edges EG, occurrence of a dark line resulting from propagation of such a region can be suppressed. Also, since the direction of rotation of the liquid crystal molecules LM at the on-time is determined uniquely, even if a stress of external pressure is applied, the liquid crystal molecules LM can rotate in a predetermined direction, a desired alignment state can be formed, and non-uniformity in display can be suppressed.

Further, according to the present embodiment, the edges EG of the pixel electrode PE include portions intersecting the initial alignment direction AL0 of the liquid crystal molecules LM at a relatively large angle. An electric field which can be produced in these portions can rotate the liquid crystal molecules LM at high speed. Accordingly, it is possible to increase a liquid crystal response speed corresponding to a time required for stabilizing the alignment state of the liquid crystal molecules LM from the start of voltage application to produce an electric field. In the example illustrated in FIG. 5, the liquid crystal molecules LM near portion E3 of the edges EG tend to be rotated faster than the liquid crystal molecules LM near portion E4. Also, the rotation speed of the liquid crystal molecules LM near portion E4 is increased because of the liquid crystal molecules LM near the portion E3. Accordingly, the liquid crystal response speed can be increased for substantially the entire area along the edges EG.

Meanwhile, the thickness of the alignment film affects the sensitivity to an electric field which acts on the liquid crystal molecules LM. That is, the electric field does not easily act on the liquid crystal molecules LM in a region where the alignment film is thick as compared to a region where the alignment film is thin. Accordingly, when the thickness of the alignment film within a pixel is nonuniform, the alignment state of the liquid crystal molecules LM in a region in which the alignment film is thick is different from that of a region in which the alignment film is thin, and degradation in display quality may be caused.

According to the present embodiment, since each of the edges EG of the pixel electrode PE is bent, the electric field which acts on the liquid crystal molecules LM at the on-time is produced along different directions in the respective portions of the edge EG. The produced electric fields act to align the liquid crystal molecules LM in slightly different directions. Accordingly, even if the thickness of the alignment film is nonuniform in a pixel, regions in which the alignment states are different are mixed along the edges EG which are bent at several points, and the non-uniformity is spatially dispersed. Thereby, degradation in display quality which results from a difference in the alignment states becomes hard to be recognized.

As described above, according to the present embodiment, a display quality can be improved.

Next, the relationship between the first angle θ1 and the second angle θ2 and a V-T characteristic will be described. The V-T characteristic described in this specification represents the relationship between a voltage (V) applied to the liquid crystal layer LC and a transmittance of the display panel PNL.

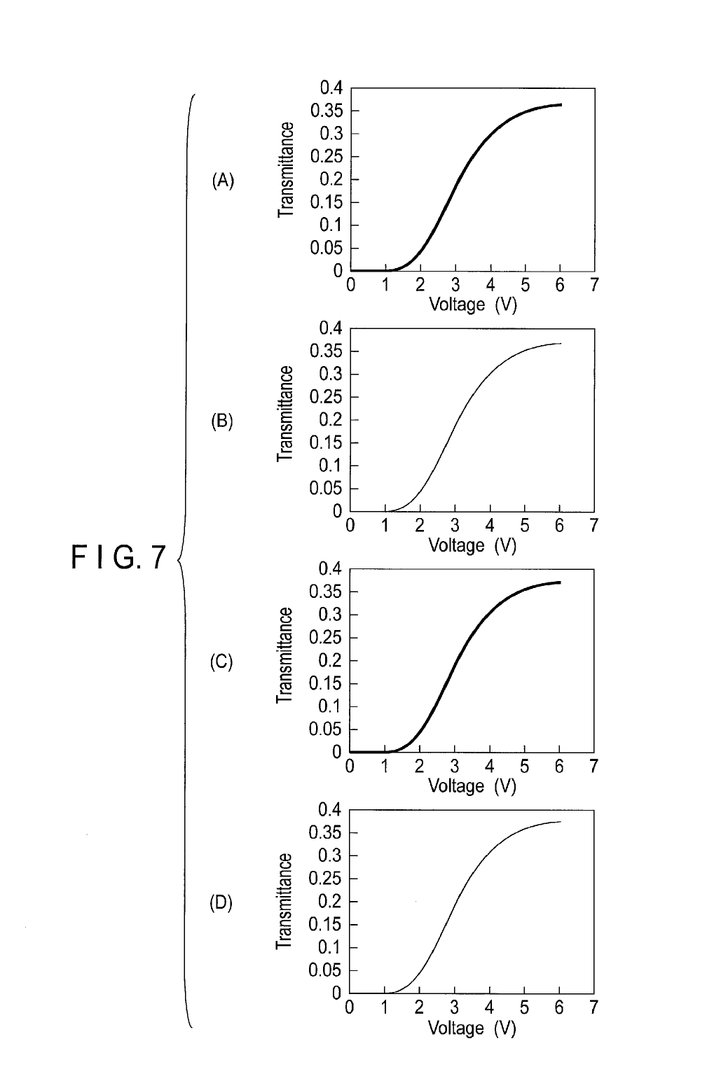

FIG. 7 represents graphs each showing the simulation result of the V-T characteristic of a case where a negative liquid crystal material is applied. In (A) to (D) of the drawing, the horizontal axis represents the applied voltage, and the vertical axis represents the transmittance.

Graph (A) of the drawing shows the V-T characteristic of a case where the pixel electrode PE has linear edges EG. The first angle θ1 and the second angle θ2 are both 15°. The transmittance is 0.333 (33.3%) when the applied voltage is 4.5 V, and the transmittance is 0.351 (35.1%) when the applied voltage is 5 V.

Graphs (B) to (D) of the drawing each shows the V-T characteristic of a case where the pixel electrode PE has bent edges EG.

Graph (B) corresponds to a case where the first angle θ1 is 20° and the second angle θ2 is 10°. The transmittance is 0.334 (33.4%) when the applied voltage is 4.5 V, and the transmittance is 0.353 (35.3%) when the applied voltage is 5 V.

Graph (C) corresponds to a case where the first angle θ1 is 30° and the second angle θ2 is 0°. The transmittance is 0.342 (34.2%) when the applied voltage is 4.5 V, and the transmittance is 0.360 (36.0%) when the applied voltage is 5 V.

Graph (D) corresponds to a case where the first angle θ1 is 25° and the second angle θ2 is 5°. The transmittance is 0.342 (34.2%) when the applied voltage is 4.5 V, and the transmittance is 0.359 (35.9%) when the applied voltage is 5 V.

According to the above simulation results, it has been confirmed that the transmittance could be improved in all of cases (B) to (D) in which the pixel electrode PE has the bent edges EG, as compared to case (A) in which the pixel electrode PE has the linear edges EG. In particular, as indicated in (C) and (D), when a difference (θ1−θ2) between the first angle θ1 and the second angle θ2 is 20° or more, it has been confirmed that the transmittance could be increased by approximately 2% as compared to (A).

Also, when a positive liquid crystal is applied, the initial alignment direction of the liquid crystal molecules conforms to AL0, as shown in FIG. 6. The initial alignment direction AL0 is the direction which is orthogonal to the gate line. When the edge EG of the pixel electrode is bent relative to the initial alignment direction AL0 in such a way that the first angle θ1 is set at 10° and the second angle θ2 is set at 0°, for example, the transmittance was improved by 3.6% as compared to a case where the edges are extended straight at an angle of 5° without forming the edge portion to be bent. Improvement in the transmittance was also confirmed when the edge EG is bent in such a way that the first angle θ1 is set at 8° and the second angle θ2 is set at 2°. That is, when a positive liquid crystal is applied, each of the edges should preferably be formed to be bent in the following ranges:

5°≦θ1≦20°,0°≦θ2≦10°, and θ1>θ2≧0.

Also, preferably, the relationship, θ1−θ2>5°, should be satisfied.

Next, the relationship between the first angle θ1 and the second angle θ2 and a liquid crystal response time will be described. Here, the liquid crystal response time is defined as a time required for a transmittance to reach 90% from 10%, when the maximum transmittance which can be obtained when a voltage corresponding to a specific gradation is applied to the liquid crystal layer LC is set at 100%.

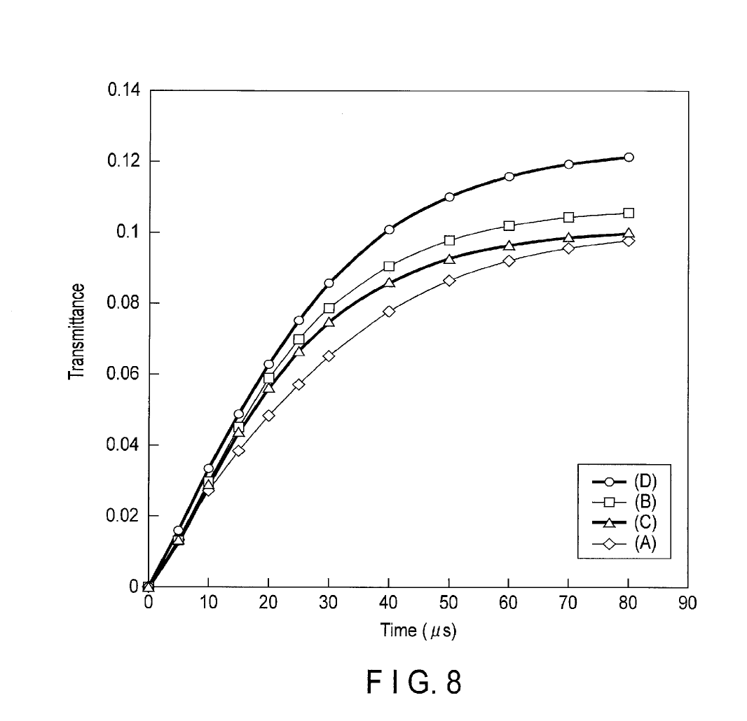

FIG. 8 is a graph showing the simulation result of the liquid crystal response time of a case where a negative liquid crystal material is applied. In the drawing, the horizontal axis represents the time (μs), and the vertical axis represents the transmittance. Here, a liquid crystal response time when a voltage (2.5 V) corresponding to a halftone is applied to the liquid crystal layer LC was calculated. Plots (A) to (D) of FIG. 8 correspond to cases (A) to (D) described referring to FIG. 7, respectively.

The liquid crystal response time of (A) was 49 μs. The liquid crystal response time of (B) was 42 μs. The liquid crystal response time of (C) was 42 μs. The liquid crystal response time of (D) was 46 μs. According to the above simulation results, it has been confirmed that the liquid crystal response time could be reduced in all of cases (B) to (D) in which the pixel electrode PE has the bent edges EG, as compared to case (A) in which the pixel electrode PE has the linear edges EG. In particular, as indicated in (B) to (D), when a difference (θ1−θ2) between the first angle θ1 and the second angle θ2 is 10° or more, it has been confirmed that the liquid crystal response time could be reduced by approximately 16% as compared to (A), and that a liquid crystal response speed can be increased.

Next, another structure example of the present embodiment will be described. In the description below, main differences will be described, and the structures which are the same as those in the above-described example are denoted by the same reference numbers, and a detailed description of them is omitted.

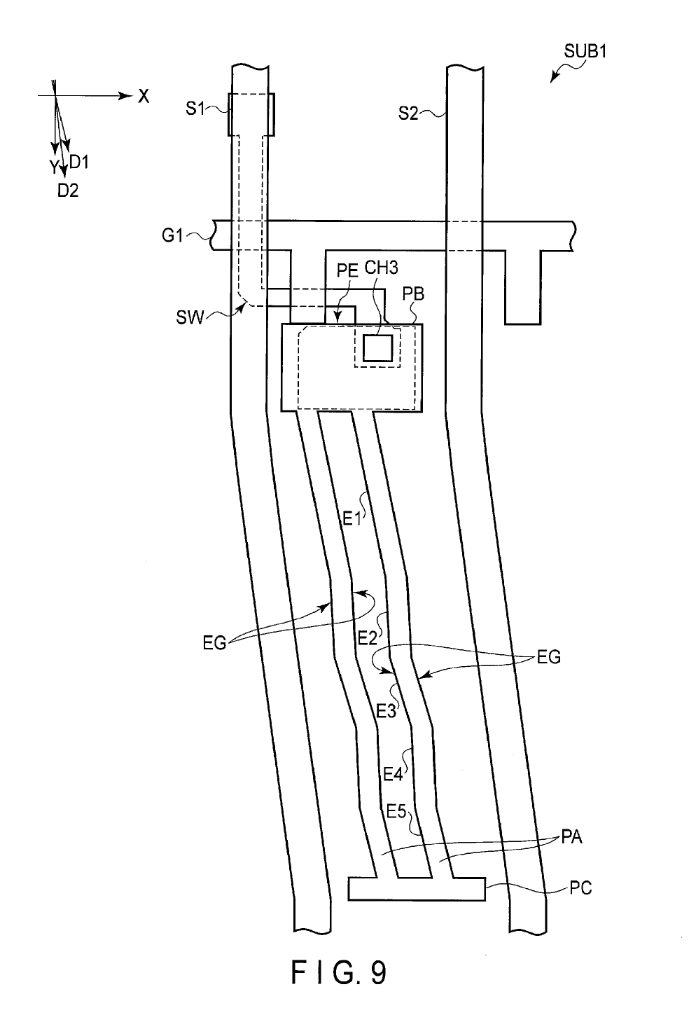

FIG. 9 is a plan view showing another structure example of one pixel PX in the first substrate SUB1 shown in FIG. 1. In the structure example shown in FIG. 9, the shape of the strip electrode PA or the edge EG of the strip electrode PA is different as compared to the structure example shown in FIG. 2. More specifically, in the strip electrode PA, a portion connected to the contact portion PB is longer than a portion connected to the connecting portion PC. When the edges EG are noted, in the example illustrated, each of the edges EG includes portions E1 to E5. Portions E1 to E5 are arranged in the second direction Y in this order. Portion E1 is connected to the contact portion PB, and portion E5 is connected to the connecting portion PC. Portions E2 to E4 correspond to a middle part located between portion E1 and portion E5. Portions E2 to E4 constitute the middle part in which portions extending in different directions are adjacent to each other and form a bent configuration. In the example illustrated, portions E1, E3, and E5 extend in direction D1. Portions E2 and E4 extend in direction D2. The length of portion E1 is longer than the other portions E2 to E5.

Also in this structure example, the same advantage as that of the above structure example can be obtained. In addition, portion E1 connected to the contact portion PB is longer than portions E2 to E5, and extends in a direction which crosses the second direction Y (reference direction) at a relatively large angle. Accordingly, even if the thickness of the alignment film is nonuniform in an area which overlaps the contact portion PB in the X-Y plane, in particular, at a periphery of an area which overlaps the contact hole CH3, an electric field produced along portion E1 of each of the edges EG acts on the liquid crystal molecules LM at a relatively long distance, and the liquid crystal molecules LM can be aligned in a desired direction. Consequently, degradation in display quality can be suppressed.

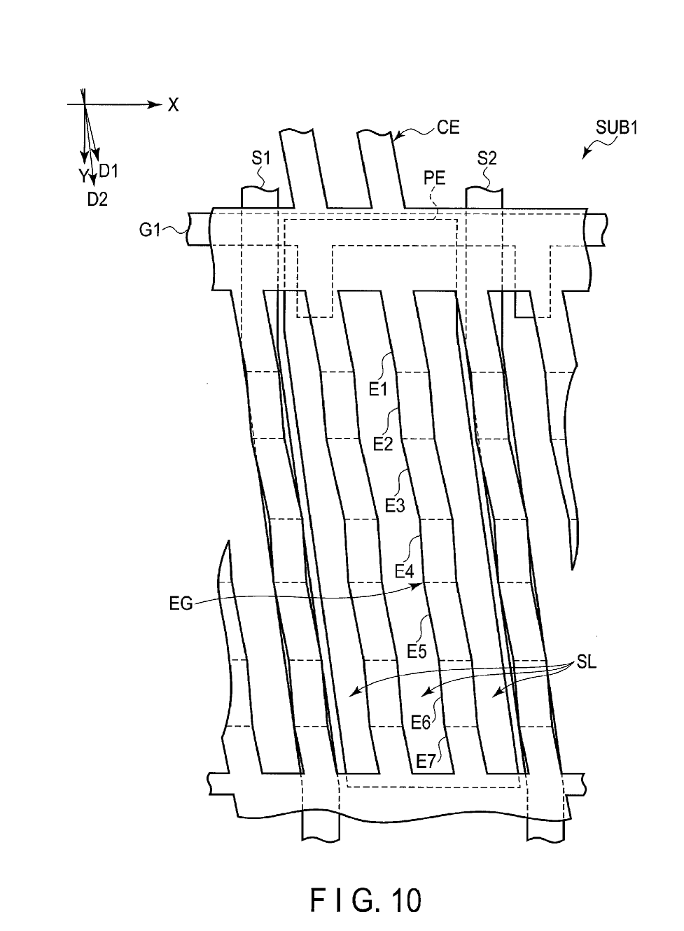

FIG. 10 is a plan view showing yet another structure example of one pixel PX in the first substrate SUB1 shown in FIG. 1. The structure example shown in FIG. 10 is different from the structure example shown in FIG. 2 in that the pixel electrode PE is formed in a flat plate-like shape without a slit, and that the common electrode CE is located above the pixel electrode PE and includes slits SL. Note that only the main parts necessary for explanation are depicted here, and thus the switching elements, the relay electrodes, etc., are omitted.

The pixel electrode PE is located between the source lines S1 and S2, and is formed in an insular shape. The common electrode CE is located on the layer above the gate line G1, the source lines S1 and S2, and the pixel electrode PE. Also, the common electrode CE includes the slits SL which are opposed to the pixel electrode PE. In the example illustrated, the common electrode CE corresponds to the second electrode, and the pixel electrode PE corresponds to the first electrode.

Edges EG which define the slits SL are constituted similarly to the edges EG of the strip electrode PA shown in FIG. 2. In the example illustrated, each of the edges EG includes portions E1 to E7 arranged in the second direction Y in this order. Portions E2 to E6 correspond to a middle part located between portion E1 and portion E7. Portions E2 to E6 constitute the middle part in which portions extending in different directions are adjacent to each other and form a bent configuration. Portions E1, E3, E5, and E7 extend in direction D1. Portions E2, E4, and E6 extend in direction D2. An angle that directions D1 and D2 form with the second direction Y is as described with reference to FIG. 2.

Note that the shape of the slit SL, or the shape of the edge PG is not limited to the illustrated example, and the number of portions included in the edge EG is also not limited to the illustrated example. For example, in the portions of the strip electrode close to joint parts such as the contact portion PB and the connection portion PC, the alignment of liquid crystal molecules easily becomes unstable. Therefore, the angle of each of portions E1 and E7 (E5 in the embodiment shown in FIG. 9) can be made different from the angle of each of portions E3 and E5 (portion E3 in the embodiment shown in FIG. 9).

Also in this structure example, the same advantage as that of the above structure example can be obtained.

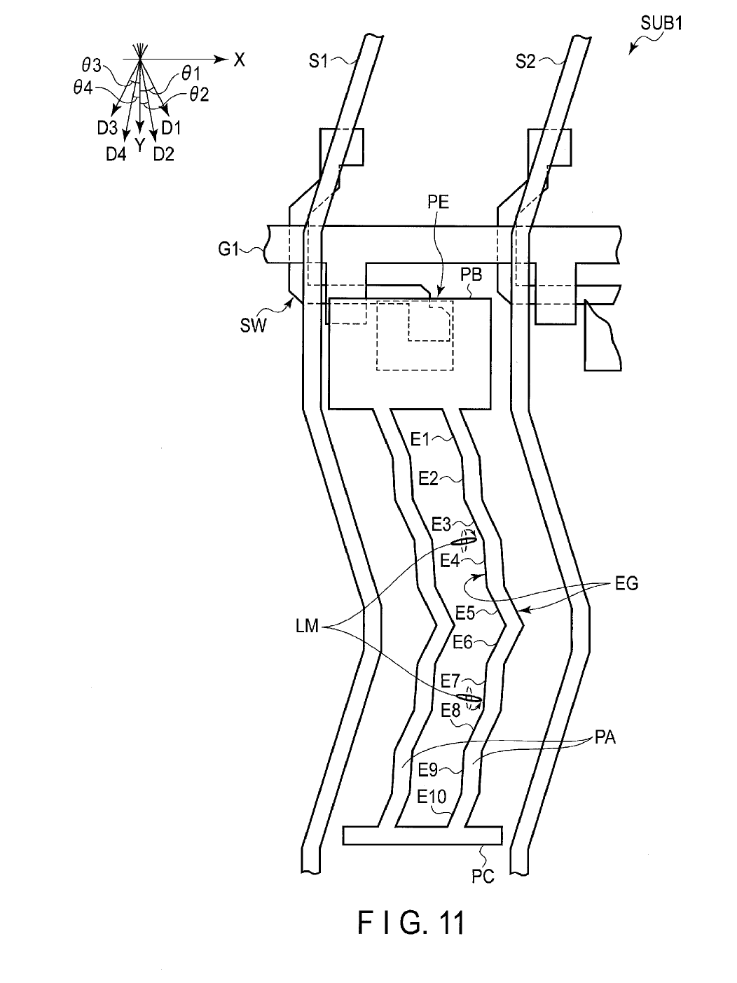

FIG. 11 is a plan view showing yet another structure example of one pixel PX in the first substrate SUM shown in FIG. 1. In the structure example shown in FIG. 11, the shape of the strip electrode PA or the edge EG of the strip electrode PA is different as compared to the structure example shown in FIG. 2. More specifically, in the strip electrode PA of the pixel electrode PE, each of the edges EG includes portions E1 to E10 arranged in the second direction Y in this order.

Portions E2 to E4 correspond to a middle part located between portion E1 and portion E5. Portions E2 to E4 constitute the middle part in which portions extending in different directions are adjacent to each other and form a bent configuration. Portions E1, E3, and E5 extend in direction D1. Portions E2 and E4 extend in direction D2. An angle that directions D1 and D2 form with the second direction Y is as described with reference to FIG. 2.

Portions E7 to E9 correspond to a middle part located between portion E6 and portion E10. Portions E7 to E9 constitute the middle part in which portions extending in different directions are adjacent to each other and form a bent configuration. Each of portions E6, E8, and E10 extends in direction D3 which intersects the second direction Y at a third angle θ3. Each of portions E7 and E9 extends in direction D4 which intersects the second direction Y at a fourth angle θ4. Directions D3 and D4 are directions intersecting the second direction Y clockwise at an acute angle. The third angle θ3 is different from the fourth angle θ4. In one example, the third angle θ3 is substantially the same as the first angle θ1, and the fourth angle θ4 is substantially the same as the second angle θ2. However, the angles are not limited to the above example.

In a region corresponding to portions E1 to E5 adjacent to the contact portion PB, the liquid crystal molecules LM form a region in which the liquid crystal molecules LM are rotated in the same direction at the on-time. Also, in a region corresponding to portions E6 to E10 adjacent to the connecting portion PC, the liquid crystal molecules LM form a region in which the liquid crystal molecules LM are rotated in the same direction at the on-time. However, in the region corresponding to portions E1 to E5 and the region corresponding to portions E6 to E10, the directions of rotation of the liquid crystal molecules LM are different from each other.

For example, when a positive liquid crystal material is applied, the liquid crystal molecules LM are initially aligned in the second direction Y, as shown by a dotted line in the drawing. In the region corresponding to portions E1 to E5, the liquid crystal molecules LM are rotated clockwise as illustrated by a solid line and form a substantially single domain at the on-time. In the region corresponding to portions E6 to E10, the liquid crystal molecules LM are rotated anticlockwise as illustrated by a solid line and form a substantially single domain at the on-time. When a negative liquid crystal material is applied, the liquid crystal molecules LM are initially aligned in the first direction X.

According to such a structure example, as well as being to obtain an advantage similar to those of the above-described structure examples, two domains can be formed per one pixel. Accordingly, a viewing angle can be optically compensated in a plurality of directions, and achieving a wide viewing angle is enabled. Further, in FIG. 11, although the strip electrode is formed to be projected to the right in the drawing, it may be formed to be projected to the left in the drawing. In this case, directions D1 to D4 are those which are symmetrical with respect to the second direction Y.

As described above, a liquid crystal display device capable of improving the display quality can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a first substrate including a first line, a second line separated from the first line, a first electrode, a second electrode opposed to the first electrode, and an interlayer insulating film located between the first electrode and the second electrode;
a second substrate opposed to the first substrate; and
a liquid crystal layer including liquid crystal molecules which is held between the first substrate and the second substrate,
the second electrode comprising an edge located between the first electrode and the liquid crystal layer,
the edge comprising a first portion located closer to the first line, a second portion located closer to the second line, and a middle part which is located between the first portion and the second portion and is bent, and
the liquid crystal molecules form a region, between the first portion and the second portion, in which the liquid crystal molecules are rotated in a same direction by an electric field produced between the first electrode and the second electrode.

2. The liquid crystal display device of claim 1, wherein the middle part comprises a third portion extending in a direction which crosses a reference direction orthogonal to the first line at a first angle, and a fourth portion extending in a direction which crosses the reference direction at a second angle different from the first angle.

3. The liquid crystal display device of claim 2, wherein
the liquid crystal layer is a negative liquid crystal layer, and
the first angle and the second angle satisfy the following relationships:
10°≦θ1≦30°,0°≦θ2≦20°, and θ1°>θ2≧0,
where θ1 is the first angle, and θ2 is the second angle.

4. The liquid crystal display device of claim 3, wherein the first angle and the second angle satisfy the relationship, θ1−θ2≧20°.

5. The liquid crystal display device of claim 3, wherein the first angle and the second angle satisfy the relationship, θ1−θ2≧10°.

6. The liquid crystal display device of claim 2, wherein
the liquid crystal layer is a positive liquid crystal layer, and
the first angle and the second angle satisfy the following relationships:
5°≦θ1≦20°,0°≦θ2≦10°, and θ1°>θ2≧0,
where θ1 is the first angle, and θ2 is the second angle.

7. The liquid crystal display device of claim 6, wherein the first angle and the second angle satisfy the relationship, θ1−θ2≧5°.

8. The liquid crystal display device of claim 2, wherein the first portion and the second portion extend in a direction which crosses the reference direction at the first angle.

9. The liquid crystal display device of claim 1, further comprising a switching element electrically connected to the first line, wherein
the first line is a first gate line,
the second line is a second gate line, and
the second electrode is electrically connected to the switching element, and comprises a strip electrode including the edge.

10. The liquid crystal display device of claim 1, further comprising a switching element electrically connected to the first line, wherein
the first line is a first gate line,
the second line is a second gate line, the first electrode is electrically connected to the switching element, and
the second electrode comprises a slit including the edge.

11. The liquid crystal display device of claim 1, wherein:
the edge further comprises a fifth portion located closer to the second line than from the second portion; and
the liquid crystal molecules form a region,
between the second portion and the fifth portion, in which the liquid crystal molecules are rotated in a direction different from that of the region between the first portion and the second portion.

12. A liquid crystal display device comprising:
a first substrate including a first electrode, a second electrode opposed to the first electrode, and an interlayer insulating film located between the first electrode and the second electrode;
a second substrate opposed to the first substrate; and
a liquid crystal layer including liquid crystal molecules which is held between the first substrate and the second substrate,
the second electrode comprising an edge located between the first electrode and the liquid crystal layer,
the edge comprising a first portion, a second portion, and a middle part which is located between the first portion and the second portion and is bent,
the middle part comprising a third portion extending parallel to the first portion, and a fourth portion extending in a direction different from a direction in which the third portion extends, and
the liquid crystal molecules form a region, between the first portion and the second portion, in which the liquid crystal molecules are rotated in a same direction by an electric field produced between the first electrode and the second electrode.

13. A liquid crystal display device comprising:
a first substrate including a first electrode, a second electrode opposed to the first electrode, and an interlayer insulating film located between the first electrode and the second electrode;
a second substrate opposed to the first substrate; and
a liquid crystal layer including liquid crystal molecules which is held between the first substrate and the second substrate,
the second electrode comprising an edge located between the first electrode and the liquid crystal layer,
the edge being constituted of first portions and second portions which are arranged alternately, the second portions extending in a direction different from a direction in which the first portions extend, and
the liquid crystal molecules form a region, along the edge, in which the liquid crystal molecules are rotated in a same direction by an electric field produced between the first electrode and the second electrode.
